(19) United States
(12) Patent Application Publication
(10) Pub. No.: US 2011/0018724 A1
(43) Pub. Date: Jan. 27, 2011

(54) Sensor for detecting water level for watercraft trailer

(76) Inventors: Mark J. Little, Oakdale, MN (US); Mark Ebbenga, Forest Lake, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/824,592

(22) Filed: Jun. 28, 2010

Related U.S. Application Data
(60) Provisional application No. 61/220,600, filed on Jun. 26, 2009.

(51) Int. Cl. G08B 21/00

(52) U.S. Cl. 340/618

(57) ABSTRACT

A device system includes a transmitter assembly and a receiver assembly. The transmitter assembly includes a frequency transmitter having an antenna and a first plurality of electrically conductive elements. The receiver assembly includes a frequency receiver having an antenna and an annunciator. Immersion of at least a portion of each of the first plurality of conductive elements in water causes the frequency transmitter to transmit a frequency via its antenna to the antenna of the frequency receiver, thereby causing a first annuciation by the annunciator.

### CROSS REFERENCE TO RELATED APPLICATION

The present application is based on and claims the benefit of U.S. Provisional Patent Application Ser. No. 61/220,600, filed Jun. 26, 2009, the content of which is hereby incorporated by reference in its entirety.

### BACKGROUND

A problem common to watercraft owners who trailer their power and sail boats, pontoons, or personal watercraft is that of having to launch their equipment from towed trailers. Launching necessities that the trailer and supported craft be backed into the water sufficiently to float the craft or permit the craft to be pushed from the trailer bunks or rollers. If the watercraft is floating, the trailer is sufficiently submerged to facilitate mounting the craft.

Depending upon the watercraft launch facility, water level and visibility of the trailer from the towing vehicle or from the associated mirrors, it is often difficult to know when watercraft floatation is achieved. The launching and loading of pontoon boats and large watercraft can be especially difficult since view of the trailer is frequently obscured by the watercraft. Without an assistant, the vehicle operator may have to make repeated physical inspections to determine the relative positions of the towing vehicle, trailer and watercraft to determine if the watercraft can be launched.

### SUMMARY

A device system comprises a transmitter assembly and a receiver assembly. The transmitter assembly comprises a frequency transmitter having an antenna and a first plurality of electrically conductive elements. The receiver assembly comprises a frequency receiver having an antenna and an annuciator. Immersion of at least a portion of each of the first plurality of conductive elements in water causes the frequency transmitter to transmit a frequency via its antenna to the antenna of the frequency receiver, thereby causing a first annuciation by the annunciator.

### BRIEF DESCRIPTION OF THE DRAWINGS

FIG. 1 is a perspective view showing a watercraft on a watercraft trailer that is hitched to a motor vehicle, wherein the watercraft is being backed into a body of water.

FIG. 2 is a side view of a watercraft trailer ready to be backed down the launch ramp into the body of water.

FIG. 3 is a side view similar to FIG. 2, showing the watercraft trailer farther down the launch ramp and the watercraft lifting off.

FIG. 4 is a perspective view of an exemplary transmitter assembly of the present disclosure.

FIG. 5 is a schematic diagram of an exemplary transmitter assembly.

FIG. 6 is a perspective view of an exemplary receiver assembly of the present disclosure.

FIG. 7 is a schematic diagram of an exemplary receiver assembly.

### DETAILED DESCRIPTION

The present disclosure relates to a water level monitor system for use with a watercraft trailer and, in particular, to a radio frequency (RF) monitor for detecting and annunciating the floatation of and/or ability to launch a trailer-supported watercraft. Such watercraft include, for example, a boat, kayak, paddle craft, pontoon, sailboat, or personal watercraft, among a variety of recreational and commercial watercraft vehicles.

A transmitter is located on a watercraft trailer that is towed by a motor vehicle. A watercraft is carried on the trailer and is backed into a body of water by the motor vehicle via a launch ramp. A receiver indicates to a driver of the motor vehicle that the watercraft is adequately submerged to accomplish the task of launching the watercraft into the body of water.

The water level detection system of the present disclosure provides a watercraft trailer-mounted assembly that detects and communicates a predetermined launch condition of the trailer and/or towing vehicle relative to the water surface level. The transmitter assembly mounts to the trailer or towing vehicle. With the immersion of the transmitter and resulting conduction between exposed probes thereon, an RF communication causes an audible, tactile and/or visual annunciation signal by a receiver assembly that alerts the vehicle operator that the trailer and watercraft are in a condition conducive to launching or loading the watercraft.

In an exemplary embodiment, transmitter assembly 26 and receiver assembly 38 are contemplated as separate units that communicate by radio frequency. Because the units are separate, the transmitter assembly 26 may be mounted at a location for water submersion. The receiver assembly 38 can be located in a towing motor vehicle, proximate the vehicle operator. Wireless communication between the transmitter assembly 26 and receiver assembly 38 allow for ease and flexibility of use.

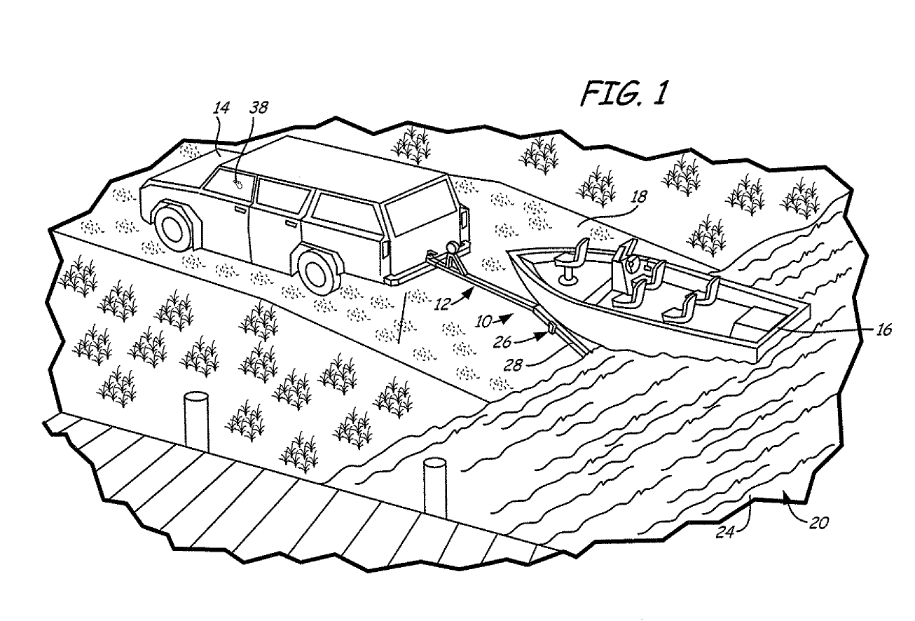

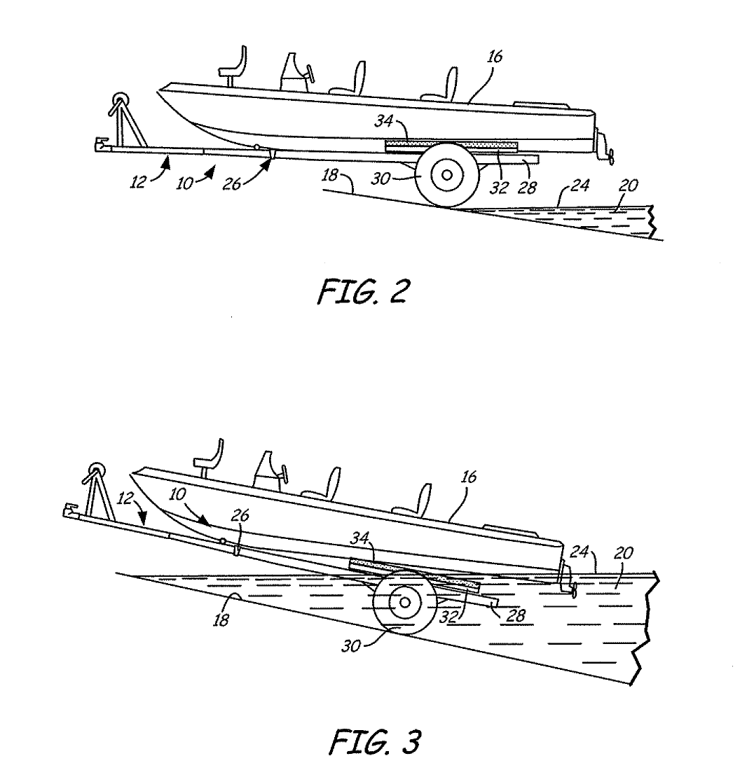

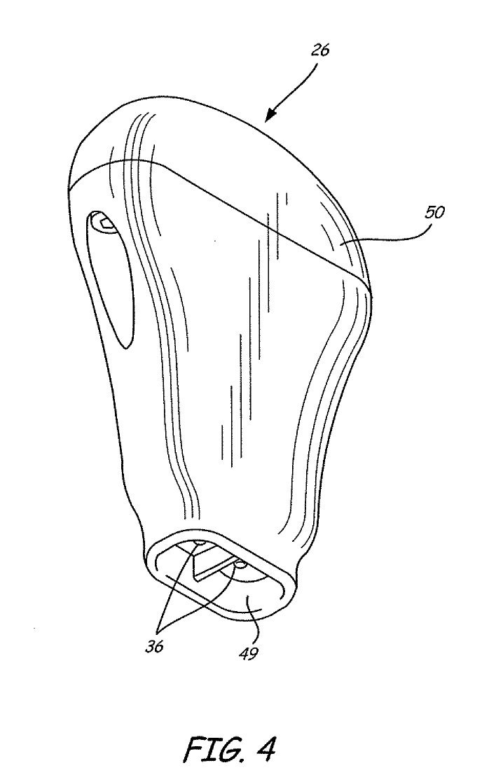

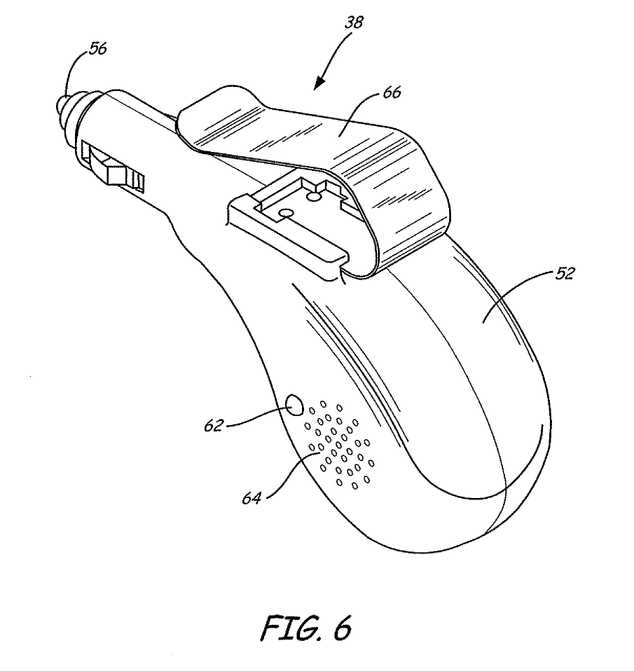

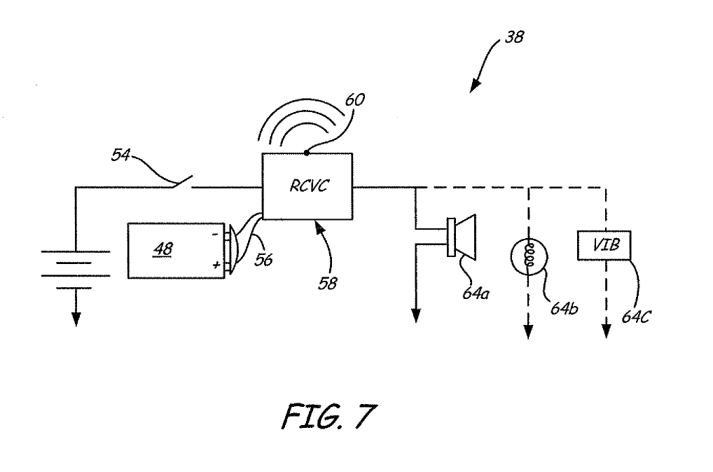

FIGS. 1 through 7 illustrate a water level monitor system 10 for use with a watercraft trailer 12 hitched to a motor vehicle 14 for hauling a watercraft 16 to a launch ramp 18 that extends into a body of water 20. A transmitter assembly 26 is attached to watercraft trailer 12, which can be backed just the right distance down launch ramp 18 and into the body of water 20 to accomplish the task of launching the watercraft 16 onto the water surface 24.

In an exemplary embodiment, watercraft trailer 12 includes a bed frame 28. A wheel assembly 30 and a pair of bunk members 32 are connected to the bed frame 28. A pair of berth pads 34 is provided, with each mounted onto one bunk member 32, so as to carry the watercraft 16 thereon.

In an exemplary embodiment, water level monitor system 10 of the disclosure has an RF transmitter assembly 26 and an associated RF receiver assembly 38. The transmitter assembly 26 includes one or more exposed (i.e. non-electrically-insulated) conductive elements 36 that are positioned to be immersed in the water. Transmitter assembly 26 can be positioned at any desired location along the trailer 12, a tow vehicle (e.g., bumper) or the supported watercraft, such as by the use of a mounting bracket, pressure-sensitive adhesive, or other known mounting methods and means. In an exemplary embodiment, the transmitter assembly 26 is mounted at a location protected from normal launch activities, road hazards or other possible damage-inducing conditions. A variety of appropriate fasteners, clips, straps or the like can be adapted to the external housing 50 of the transmitter assembly 26 to accommodate temporary or permanent mountings. A temporary mounting is advantageous in that the transmitter assembly 26 can be mounted just before launching and removed when the launching activity is completed to prevent loss or damage. Moreover, the mounting location can be easily changed for different watercraft submersion requirements. The transmitter 10 is typically located to assure optimal transmission. In an exemplary embodiment, transmitter assembly 26 is mounted to the framework 28 of the trailer 12 forward of wheel assembly 30.

In an exemplary application, transmitter assembly 26 is mounted on the watercraft trailer 12 in a position so that submersion of the conductive elements 36 occurs when the watercraft 16 lifts off of the berth pads 34 of the bunk members 32, so that the watercraft 16 floats on surface 24 of the body of water 20. Upon immersion of at least a portion of each of the conductive elements 36, a conductive path is formed between conductive elements 36, thereby causing an RF transmission to the associated receiver assembly 38, which is typically located in the motor vehicle 14. The RF transmission identifies the transmitter assembly 26 to the receiver assembly 38, which in turn annunciates the immersion condition of the transmitter conductive elements 36 to the vehicle operator. Such annunciation may be made by a visual, audible and/or tactile signal produced by the receiver assembly 38.

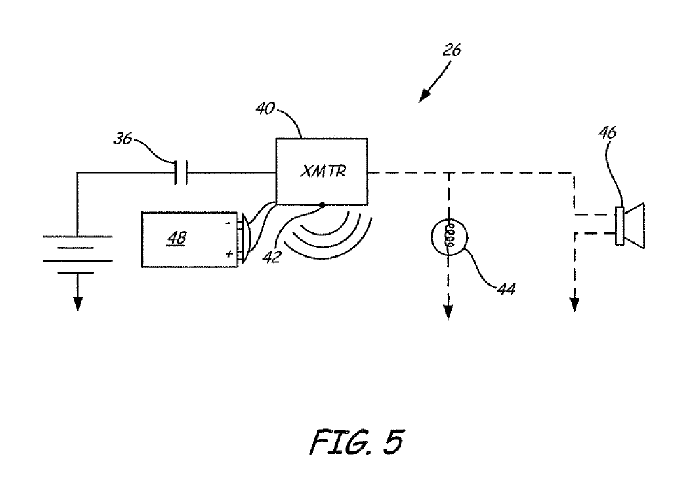

As shown schematically in FIG. 5, an exemplary transmitter assembly 26 includes RF transmitter 40, RF antenna 42, optional indicator light 44, speaker 46 and DC power source 48. The foregoing components are typically mounted in a watertight housing 50 from which conductive elements 36 extend. In an exemplary embodiment, conductive elements 36 are formed as probes or plates having exposed conductive surfaces for immersion in the body of water 20. The transmitter assembly 26 can have local visual and/or audible annunciator capability to communicate a conductor submersion condition to a person outside the vehicle or to redundantly alert the vehicle operator. A variety of wired or wireless DC powered annunciators may be coupled to the transmitter.

Upon backing the trailer 12 into a body of water 20, spaced-apart conductive elements 36 are immersed in the water. This results in the formation of a conductive path between DC power source 48 (e.g. battery) and RF transmitter 40. A 27 MHz RF transmitter 40 is particularly suitable, although any of a variety of other suitable RF transmitters and frequencies could be fitted to the transmitter assembly 26. An appropriate signal is communicated via the antenna 42 to the antenna 60 of receiver assembly 38 and ultimately to the tow vehicle operator. The transmitted signal can also be modulated. The transmitter assembly 26 may also include an annunciator. The annunciator emits an annunciation which can be either an indicator light 44 or an audible sound emitter such as a loud speaker 46 or equivalent transducer that emits a sound capable of being heard. Other sound emitters may emit tactile annunciations such as vibrations which are also included in this disclosure. Such an annunciation may be useful for a human launch attendant positioned near the watercraft 16.

With transmitter assembly 26 mounted in the orientation shown in FIG. 4, conductive probes 36 extend downwardly from housing 50 and are shielded by sidewall 49 from water sources, such as rain, other than body of water 20. Accordingly, unintentional completion of the circuit of transmitter assembly 26 is prevented.

Portions of the trailer 12 framework may also be adapted as conductive elements. Additional conductive elements that are vertically offset may also be included so that multi-staged transmissions may occur as the transmitter assembly 26 is progressively immersed to greater depths. Depending upon water currents, complete watercraft floatation may be preferred versus shallower immersion that requires winching. For example, submersion to a first depth may produce a first signal indicative of a minimal launch condition with the watercraft 16 still in contact with the trailer rollers or bunk members 32. Shorting of a second set of conductive elements may produce a second signal at a deeper depth that indicates complete floatation. In either of the foregoing events, the operator of the towing vehicle is made aware of a possible launch condition without having to physically view the condition of the trailer 12 and supported watercraft 16. That is, wireless communication between the transmitter assembly 26 and the receiver assembly 38 assures the operator that the watercraft 16 is either floating or can be readily pushed from or loaded onto the trailer 12.

In an exemplary embodiment, receiver assembly 38 includes a housing 52 having an on/off switch 54; a DC power source connector 56 for connection to battery or vehicle power, for example; an appropriate RF receiver 58 tuned to the frequency of RF transmitter 40; antenna 60; on or charging indicator light 62; annunciator 64 (e.g. audible speaker 64a and/or visual light 64b and/or tactile vibrator 64c); clip 66; and associated circuitry. In an exemplary application, the receiver assembly 38 is selectively turned on during launching operations. Upon immersion of the conductive elements 36 of the transmitter assembly 26, the receiver assembly 38 receives an RF transmission from RF transmitter 40 via antenna 60 and alerts the operator via annuciator 64. The receiver assembly 38 may also or alternatively use the vehicle's radio/speaker, wireless telephone, etc., depending upon the transmission frequency of RF transmitter 40. Receiver assembly 40 may be held in position within motor vehicle 14 by inserting DC power source connector 56 into a cigarette lighter receptacle of motor vehicle 40 or other 12-volt power outlet. Clip 66 also allows receiver assembly 38 to be easily mounted to a vehicle visor or clipped to the operator's clothing, for example.

In lieu of using a separately packaged receiver assembly 38, the RF transmitter 40 might be selected and configured to communicate directly with a vehicle radio speaker as the receiver assembly. For example, upon turning on the radio, a launch alert transmission might be received at any desired channel or generally as noise/static over a programmed channel. Alternatively, the RF transmitter 40 might be adapted to communicate with another frequency-sensitive device such as a handheld walkie-talkie radio tuned to an appropriate channel or a wireless phone and thereby utilize available annunciators of the foregoing devices.

While the invention has been described with respect to several presently considered alternative constructions and considered improvements or alternatives thereto, still other constructions or combination may be suggested to those skilled in the art. For example, in lieu of a RF communications link 16, other wireless links and other frequencies (e.g. infrared, broadband) might be adapted to the invention. The foregoing description should therefore be construed to include all those embodiments within the spirit and scope of the following claims.

Although the present invention has been described with reference to preferred embodiments, workers skilled in the art will recognize that changes may be made in form and detail without departing from the spirit and scope of the invention.

What is claimed is:

1. A device system comprising:
a transmitter assembly comprising:
a frequency transmitter having an antenna; and
a first plurality of electrically conductive elements; and
a receiver assembly comprising:
a frequency receiver having an antenna; and
an annuciator;
wherein immersion of at least a portion of each of the first plurality of conductive elements in water causes the frequency transmitter to transmit a frequency via its antenna to the antenna of the frequency receiver, thereby causing a first annuciation by the annunciator.

2. The device system of claim 1 wherein the frequency is a radio frequency.

3. The device system of claim 1 wherein the frequency is an infrared frequency.

4. The device system of claim 1 wherein the frequency is a broadband frequency.

5. The device system of claim 1 wherein the annunciation is audible.

6. The device system of claim 1 wherein the annunciation is visible.

7. The device system of claim 1 wherein the annunciation is tactile.

8. The device system of claim 1 wherein immersion of at least a portion of each of the conductive elements in water causes the conductive elements to complete an electrical circuit.

9. The device system of claim 1 wherein the transmitter assembly further comprises:
a second plurality of electrically conductive elements displaced from the first plurality of electrically conductive elements;
wherein immersion of at least a portion of each of the second plurality of conductive elements in water causes the frequency transmitter to transmit the frequency via its antenna to the antenna of the frequency receiver, thereby causing a second annuciation by the annunciator.

10. The device system of claim 1 wherein the transmitter assembly further comprises a power source.

11. The device system of claim 1 wherein the receiver assembly further comprises a power source connector.

12. The device system of claim 11 wherein the power source connector is configured for insertion into a vehicle cigarette lighter receptacle.

13. The device system of claim 1 wherein the annuciator is a vehicle speaker.

14. The device system of claim 1 wherein the annuciator is a walkie-talkie radio.

15. The device system of claim 1 wherein the annuciator is a wireless phone.

16. The device system of claim 1 wherein the transmitter assembly further comprises a housing from which each of the first plurality of conductive elements extends.

17. The device system of claim 16 wherein the housing prevents unintentional shorting of the first plurality of conductive elements when at least a portion of each of the first plurality of conductive elements is not immersed in water.
